(19) United States
(12) Patent Application Publication
(10) Pub. No.: US 2016/0257801 A1
(43) Pub. Date: Sep. 8, 2016

(54) A FIRE-RESISTANT MATERIAL AND A METHOD FOR OBTAINING A FIRE-RESISTANT MATERIAL

(71) Applicant: AB MIDNIGHT HOLDING, Lemland (FI)

(72) Inventors: Hakan WIKLUND, OJA (FI); Simon WIKLUND, Lemland (FI); Jonas WIKLUND, OJA (FI)

(21) Appl. No.: 15/030,115

(22) PCT Filed: Oct. 16, 2014
(86) PCT No.: PCT/EP2014/072238

§ 371 Date: Apr. 18, 2016

(30) Foreign Application Priority Data
Oct. 17, 2013 (EP) 13189180.6

(51) Int. Cl. C08K 3/38; C09K 21/02

(52) U.S. Cl. CPC C08K 3/38; C09K 21/02

(57) ABSTRACT

A method of increasing fire resistance of a synthetic material by bringing the material into contact with a fire retardant composition including boric acid and a salt of boric acid, the fire retardant composition being free from carboxymethylcellulose. A synthetic material of increased fire resistance. A fire retardant composition and a method for preparing a fire retardant composition.

### FIELD OF THE INVENTION

The present invention relates generally to the field of fire retardant compositions and the use of such compositions in the manufacture of fire resistant materials and products. In particular, the invention relates to fire retardant compositions that may be used to improve the fire resistance of synthetic materials.

### BACKGROUND OF THE INVENTION

Each year, fires cause significant losses of life and property all over the world, and have a great impact and cost on society. To combat fire related losses, fire retardant materials have been developed, such as chemicals that can be applied to a combustible object to reduce flammability or retard the spread of fire over its surface.

For example, in the application No. PCT/FI98/00698, published as WO 99/13022, a fire-retardant is described containing boric acid (H₃BO₃), borax (Na₂B₄O₇.10H₂O or Na₂B₄O₇.5H₂O), carboxymethylcellulose (CMC) and water. Carboxymethylcellulose is stated to be necessary in order to prevent crystallization of boric acid and borax, and also is stated to bind the protective agent inside the product and on its surface. In said application, the objects that can be protected against fire are primarily wood materials or cellulosic materials.

However, in our days, synthetic materials, such as different thermoplastic and thermoelastic resins, are used in an ever increasing proportion in areas as diverse as furniture, clothing, electric and electronic apparatuses and buildings, but also in vehicles such as cars, aeroplanes, spacecraft, ships, just to mention a few. Such materials suitably should have a fire resistance suited for their intended use. The most common fire retardants used in materials such as plastics are organic halogenated compounds, especially brominated compounds. However, the impact on health and environment of such compounds, e.g. by bioaccumulation, causes some concern.

### SUMMARY OF THE INVENTION

One object of the present invention is to provide a fire retardant composition useful for increasing the fire resistance of a synthetic material.

Still another object of the present invention is to provide a fire retardant composition that may be admixed directly into a synthetic material during its processing into a product of manufacture.

Still a further object of the present invention is to provide a fire retardant composition that may be admixed not only with aqueous-based fluid materials, but also with and oil-based fluid materials, e.g. polymerizable compositions, curable polymeric compositions, paints, lacquers etc.

Another object of the present invention is to provide a fire retardant composition and a method of increasing the fire resistance of a synthetic material, such as a plastic material, with reduced impact on health and environment.

Accordingly, in a first aspect the invention relates a method of increasing fire resistance in a synthetic material by bringing the material into contact with a fire retardant composition comprising boric acid and a boric acid salt.

In another aspect, the invention relates to a synthetic material of improved fire resistance and to a product comprising such a material.

In another aspect, the invention relates to a method of manufacturing a product made from a synthetic material, by bringing the product into contact with a fire retardant composition comprising boric acid and a boric acid salt.

In another aspect, the invention relates to a method for preparing a fire retardant composition comprising admixing boric acid and a boric acid salt and optionally a liquid vehicle for the boric acid and the boric acid salt.

In still another aspect, the invention relates to a fire retardant composition comprising a mixture of boric acid and a boric acid salt, optionally dissolved in a liquid vehicle.

Further aspects, objects and advantages of the invention will become apparent from the below description, with some embodiments illustrated in the examples.

### DETAILED DESCRIPTION OF THE INVENTION

The term “synthetic material” as used herein in its broadest meaning refers to a material different from wood as well as different from a cellulosic product such as paper or cardboard.

More specifically, a synthetic material according to the present invention is a synthetic polymer, a thermosetting plastic, thermoplastic elastomer, a paint, a lacquer, a rubber, a woven fibre, a non-woven fibre, a glue, a foam, a carbon fibre, a glass fibre, or a gelcoat.

In general, the synthetic material comprises a polymeric resin. For example, a synthetic polymeric material that may be treated according to the present invention may be selected from various resins, such as polyester, epoxy, polyethylene terephthalate, polyethylene, high-density polyethylene, polyvinyl chloride, polyvinylidene chloride, low-density polyethylene, polypropylene, polystyrene, high impact polystyrene, polyamide, acrylonitrile butadiene styrene, polyethylene/acrylonitrile butadiene styrene, polycarbonate, polycarbonate/acrylonitrile butadiene styrene, polyurethane, melamine formaldehyde, phenol formaldehyde, polyetheretherketone, polyetherimide, aramide, polylactic acid, polymethyl methacrylate, polytetrafluoroethylene, urea-formaldehyde, etc.

In some embodiments, the material to be treated according to the present invention is a polymer, i.e. an organic or inorganic polymer.

The term “fire-resistance” as used herein refers the ability of a material to resist combustion when the material is exposed to high temperatures (i.e. flame retardance), and/or the ability of a material to self-extinguish flames by virtue of physico-chemical reactions that occur when it is burned (i.e. flame suppression).

The term “improved fire resistance” or “increased fire resistance”, when referring to a material treated by the fire retardant composition of the present invention, refers to the fire resistance of the material after treatment with the inventive fire retardant composition, versus before treatment with the inventive fire retardant composition.

The term “fire retardant composition” (or flame retardant composition) as used herein refers to a composition having the ability to increase the fire resistance of a material with which it is brought into contact e.g. by surface treatment of the material, impregnation of the material, or by admixing with the material or a precursor (e.g. a curable resin) of the material.

The term “fluid state” refers to the state of a material having enough fluidity to allow admixing of the fire retardant composition in those embodiments where the fire retardant composition is mixed with the material. An example of a material in a fluid state is a (non-hardened) resin, e.g. an epoxy, polyurethane or polyester resin.

### The Active Ingredient

The fire retardant composition according to the present invention comprises, as active ingredient, a mixture comprising boric acid, of chemical formula H₃BO₃, (CAS Number 10043-35-3) and a salt of boric acid. The boric acid salt may be any borate salt, but preferably is borax, also known as sodium borate, sodium tetraborate, or disodium tetraborate. For the purpose of the present invention, and unless otherwise specified or apparent from the context, the term “borax” interchangeably refers to either the anhydrous salt Na₂B₄O₇, the pentahydrate thereof, i.e. Na₂B₄O₇.5H₂O (CAS Number 12179-04-3), or the decahydrate thereof, i.e. Na₂B₄O₇.10H₂O (or Na₂[B₄O₅(OH)₄].8H₂O) (CAS Number 1330-43-4), or a mixture of any of these. In some embodiments, the boric acid salt is borax in the pentahydrate and/or decahydrate form, in particular in the decahydrate form.

The boric acid and boric acid salt components may be present in amounts such as to provide weight ratios of acid to salt of from 1:20 to 20:1, e.g. from 1:10 to 10:1, e.g. from 1:5 to 5:1, or from 1:4 to 4:1, or from 1:3 to 3:1, or from 1:2 to 2:1, e.g. a ratio of 1:1.

In some embodiments, the weight ratio between boric acid and boric acid salt is from 1:1 to 1:20, e.g. from 1:1 to 1:10, or from 1:1 to 1:5, or from 1:1 to 1:4, in particular from 1:1 to 1:3, or from 1:1 to 1:2.

In some embodiments, the weight ratio between boric acid and boric acid salt is lower than 1:1, i.e. it is from 1:2 to 1:20, e.g. from 1:2 to 1:10, or from 1:2 to 1:5, or from 1:2 to 1:4, in particular from 1:2 to 1:3.

In some embodiments, the weight ratio between boric acid and boric acid salt is higher than 1:1, e.g. it is 2:1 to 20:1, e.g. from 2:1 to 10:1, or from 2:1 to 5:1, or from 2:1 to 4:1, in particular from 2:1 to 3:1.

In some embodiments, the active ingredient is comprised of boric acid and Na₂B₄O₇.5H₂O at a weight ratio as indicated herein above.

In some embodiments, the active ingredient is comprised of boric acid and Na₂B₄O₇.10H₂O at a weight ratio as indicated herein above.

### The Fire Retardant Composition

The fire retardant composition of the present invention contains as only compulsory component the active ingredient as defined herein above.

In some embodiments, the fire retardant composition is provided in the form of a dry powder or a granulate comprising the active ingredient as defined herein above. Said powder or granulate may be obtained by simply combining together the dry ingredients and grinding, if necessary, in a grinding apparatus, such as a ball mill.

Thus, in some embodiments, the fire retardant composition is an intimate mixture of boric acid and boric acid salt, e.g. a powder mixture of the two components, with no further ingredients.

In some embodiments, the fire retardant composition further comprises a liquid vehicle for the active ingredient. The liquid vehicle e.g. may comprise water or an organic solvent, e.g. acetone or an alcohol such as glycerol, ethylene glycol, methanol, ethanol or propanol; or a mixture of any of these.

In some embodiments, the liquid vehicle is water or aqueous. In some other embodiments, the liquid vehicle is an organic solvent, e.g. an alcohol, such as glycerol, ethylene glycol, methanol, ethanol or propanol, e.g. glycerol or ethylene glycol. In some embodiments, the liquid vehicle is glycerol. In some other embodiments, the liquid vehicle is ethylene glycol.

In some embodiments, the boric acid-boric acid salt mixture (the active ingredient) constitutes at least 40%, at least 50%, at least 60%, at least 70%, at least 80%, at least 90%, at least 95%, at least 97%, or at least 99% of the fire retardant composition, or even 100% of the fire retardant composition, whereby the remaining weight percentage optionally is comprised of the liquid vehicle only.

However, in embodiments wherein a liquid vehicle is used, the amount of active ingredient admixed with the liquid vehicle generally is such as to provide a liquid composition comprising about 20 to 95 parts by weight of liquid vehicle and about 80 to 5 parts by weight of active ingredient, or 30 to 95 parts by weight of liquid vehicle and about 70 to 5 parts by weight of active ingredient; e.g. about 35 to 90 parts by weight of liquid vehicle and about 65 to 10 parts by weight of active ingredient, or about 40 to 70 parts by weight of liquid vehicle and about 60 to 30 parts by weight of active ingredient, e.g. about 50 to 60 parts by weight of liquid vehicle and about 50 to 40 parts by weight of active ingredient.

Thus, as an example, a fire retardant liquid composition of the invention may comprise about 50 to 60 parts by weight of liquid vehicle and about 50 to 40 parts by weight of active ingredient, said active ingredient consisting of boric acid and borax in a weight ratio of 1:1 to 1:3.

In some embodiments, the liquid vehicle also contains additives such as e.g. surface active agents. Such additives may be present in amounts of e.g. 1 to 15 parts by weight, e.g. 1 to 10 parts by weight or 1 to 5 parts by weight based on the total weight of the composition. The surface active agent e.g may be an ionic or non-ionic surface active agent, e.g. ionic, i.e. anionic, cationic or zwitterionic. The fire retardant composition of the invention however may also be free from any additive. In particular, the fire retardant composition of the invention does not need to contain—and suitably does not contain—any cellulosic additive such as carboxy methyl cellulose.

### The Method for Preparing a Fire Retardant Composition

According to one aspect, a method for preparing a fire retardant composition also is provided, said method comprising mixing boric acid and boric acid salt as defined herein above, and optionally a liquid vehicle as defined herein above.

The acid and salt components may be admixed with the liquid vehicle as separate components, or as a pre-blended mixture. For example, boric acid and borax, in the form of powders, may be dry blended together in any of the weight ratios indicated herein, and the powder mixture may be stored until transported to the actual site of use, where it is either admixed with a liquid vehicle before use or used as is, e.g. mixed directly into a polymeric resin.

The boric acid and boric acid salt(s) mixture (the active ingredient) preferably is dissolved in the liquid vehicle so as to obtain a solution of active ingredient in the liquid vehicle.

In preparing the fire retardant liquid composition, the active ingredient preferably is admixed with the liquid vehicle under constant or intermittent stirring. For example, the active ingredient is admixed in incremental portions with stirring during addition and stirring is continued for a time period between each addition. It is preferable that each admixed portion is allowed essentially to dissolve before adding the next portion. The portion is considered as essentially dissolved when the solution is homogeneous to the eye, i.e. no particle from the added portion remains visible.

The admixing of the active ingredient and the liquid vehicle suitably is performed at a temperature of from 15° C. up to a temperature below the boiling point of the selected liquid vehicle.

In order to obtain a homogeneous solution remaining stable over time, the liquid composition is suitably allowed to stir at a temperature of from 15° C. to a temperature below the boiling point of the selected liquid vehicle, e.g. 99° C., for a time period of at least 3 hours after completion of the admixing. Preferably, the liquid composition is stirred for a period of at least 6 hours, for a period of at least 8 hours, for a period of at least 10 hours, for a period of at least 12 hours, e.g. up to 15 hours, e.g. for a period of up to 48 hours, or for a period of up to 24 hours.

During the process of preparing the fire retardant composition, the temperature of the liquid phase preferably is kept within a range of from 15° C. and 99° C., or up to the boiling point of the liquid vehicle. For example, the temperature may be kept within a range of from 30° C. and 99° C., or between 50° C. and 99° C., e.g. between 70° C. and 99° C., e.g. between 80° C. and 99° C., or even higher, depending on the boiling point of the liquid vehicle.

The fire retardant composition obtained as a liquid phase may be concentrated by allowing at least a portion of the liquid vehicle to evaporate. In some embodiments, the fire retardant composition obtained as a liquid phase is dried by allowing the liquid vehicle to evaporate until a dry residue is obtained. Evaporation may be performed e.g. at a temperature of between 15° C. and 99° C., e.g. between 15° C. and 60° C., or between 15° C. and 40° C., such as between 15° C. and 30° C.

In one embodiment, the fire retardant in dry powder or granulate form is obtained by admixing, as generally described herein above, a liquid vehicle and boric acid, and a boric acid salt, such as borax, at a temperature of from 15 to 99° C. so as to obtain a liquid phase, and optionally removing at least a portion of the liquid vehicle, e.g. by evaporation or lyophilisation.

### Use of the Fire Retardant Composition

The fire retardant composition is added to or brought into contact with the material to be protected in an amount sufficient to improve the fire resistance of the material, and the skilled person will be able to determine such amount without undue burden.

It should be realized that the amount of fire retardant composition added to or brought into contact with the material will depend on the fire resistance that is desired or necessary, having regard e.g. to the intended use of the material. Generally, though, the fire retardant composition will be added to a material to be treated in such an amount as to provide a treated material comprising from 1 to 30 percent by weight of the fire retardant active ingredient (acid and salt), e.g. from 1 to 20 percent by weight, or from 1 to 10 percent by weight, or from 2 to 30 percent by weight, e.g. from 2 to 20 percent by weight, or from 2 to 10 percent by weight; or from 5 to 30 percent by weight, e.g. from 5 to 20 percent by weight, or from 5 to 15 percent by weight of the active ingredient, or from 5 to 10 percent by weight of the active ingredient; or from 10 to 30 percent by weight, e.g. from 10 to 20 percent by weight; or from 10 to 15 percent by weight of active ingredient, based on the total weight of material and active ingredient.

For example, in some embodiments, a fire retardant composition of the invention, comprising boric acid and borax at a weight ratio of from 1:1 to 1:3, is admixed with a polymeric resin before hardening at a weight ratio of from 10 to 15% by weight of active ingredient, based on the total weight of the fire retardant composition and the resin composition.

While generally not considered necessary in order to improve the fire resistance of the treated material, other fire retardants used within the field may also be added to the material, in combination with the fire retardant composition of the present invention.

In one advantageous embodiment, the fire retardant composition of the present invention is admixed with a synthetic polymeric material in a fluid state. A synthetic polymeric material may be selected from various polymeric resins and plastics, such as polyester, epoxy, polyethylene terephthalate, polyethylene, high-density polyethylene, polyvinyl chloride, polyvinylidene chloride, low-density polyethylene, polypropylene, polystyrene, high impact polystyrene, polyamide, acrylonitrile butadiene styrene, polyethylene/acrylonitrile butadiene styrene, polycarbonate, polycarbonate/acrylonitrile butadiene styrene, polyurethane, melamine formaldehyde, phenol formaldehyde, polyetheretherketone, polyetherimide, aramide, polylactic acid, polymethyl methacrylate, polytetrafluoroethylene, urea-formaldehyde, etc.

In one embodiment of the invention, the fire retardant composition is a liquid, e.g. aqueous, solution of active ingredient as defined herein above. It is a surprising and advantageous feature that an aqueous solution may be admixed with a polymeric material as defined herein above. For example, the present inventors have very surprisingly found that a liquid fire retardant composition according to the present invention, comprising an aqueous vehicle, may be admixed with a non-hardened resin, for instance, an epoxy resin or polyester resin, to provide a homogeneous mixture to which hardener may subsequently be added.

One aspect of the present invention therefore also refers to a method of increasing the fire resistance of a synthetic material by admixing into said material, in a fluid state, an aqueous fire retardant composition as defined herein, comprising boric acid and a salt of boric acid. Such synthetic material, which may be non-aqueous (i.e. essentially free from water) may be e.g. an oil, a petroleum product, an oil-based viscous liquid, such as an oil-based paint, a resin etc. The aqueous solution alternatively may be replaced by e.g. an alcoholic solution, e.g. an ethanol, propanol, or similar alcohol solution, e.g. glycerol or polyethylene glycol.

In some embodiments the fire retardant composition is applied to the surface of a solid synthetic material, and optionally allowed to impregnate part or all of the material. The application may be performed by any means, such as by spraying, by wet vapour, by dry vapour, by spreading, by dipping etc. In some embodiments, the fire retardant composition is allowed to penetrate into depth of the material, e.g. using an applied vacuum suction.

The application to the surface of a synthetic material may be performed at a temperature between e.g. 30 to 160° C. At the higher application temperature, the fire retardant composition is a vapour which is made to condense on the surface of the material to be treated. As an example the material to be treated, e.g. in the form of a panel, is transported on a conveyor belt into a chamber containing the fire retardant composition in vapour form.

After treatment of the synthetic material with the fire retardant composition of the present invention the material may be subjected to further processing to a desired end product. Thus, a resin may be mixed with a fire retardant composition according to the present invention, and optionally also combined with any other ingredients, e.g. conventional additives, fibre reinforcements etc., and processed to the end product by usual techniques, well known to the person of ordinary skill in the field.

In some embodiments, a synthetic material is treated by addition of a fire retardant composition according to the invention when in a fluid state, e.g. as a non-hardened plastic, and is then processed into a solid state material, e.g. by addition of hardener, and optionally further processed, and is then further brought into contact with a fire retardant composition of the invention by a surface and optionally impregnation treatment.

As noted herein above, the synthetic material to may be selected from any type of polymeric synthetic material, e.g. a thermoplastic polymer, an elastomer, or a thermosetting polymer. For example, in some embodiments, the synthetic material is a thermosetting polymer (i.e. thermosetting resin) and the fire retardant composition of the invention is added to said polymer before hardening the polymer.

In some embodiments, when the flame retardant composition comprises a liquid vehicle, such as water, the polymeric material may be submitted to a drying step after hardening. For example, drying may be performed in a convection oven, e.g. a convection oven at a temperature of from 30 to 95° C.

The synthetic material with improved fire resistance may advantageously be used as a construction material, isolation material, cable insulations, filler material, paint, surface coverings, in the productions of yarns, textiles, foams, e.g. styrofoams, polyurethane foams, honeycomb foams, in sandwich structures, composite materials, fibre reinforced plastics, gelcoats, etc. In particular, the synthetic material with improved fire resistance may suitably be used in the automotive industry, in cars, buses, lorries, aeroplanes, ships, boats, trains, spacecraft, in buildings, off-shore oil platforms, in household appliances, electronic equipment, computers, television sets, in catalysts, floor coverings, carpet paddings, plexiglass, wood-plastic composites, glues, clothes, such as functional clothes, in-door furniture , furniture fillings, e.g. seat fillings, seat fillings for automotive vehicles, interior parts for automotive vehicles, wall covers, etc.

### EXAMPLES

### Example 1

Purified water (66 parts by weight) was heated to 86° C. and at this temperature, borax (17 parts by weight) and boric acid (17 parts by weight) were added in 10 incremental portions of 1.7 parts by weight of each, with vigorous stirring and allowing each added portion (of total 3.4 parts by weight) to dissolve before adding the next portion. The obtained solution was kept under vigorous stirring at 86° C. for 3 h, then at 55° C. and gentle stirring for 12 h.

The obtained solution may be used as a flame retardant composition to increase the fire resistance of any material.

### Example 2

Water (50 parts by weight) was heated to 86° C. and at this temperature, borax (30 parts by weight) and boric acid (15 parts by weight) were added in 10 incremental portions of 3.0 parts by weight of borax and 1.5 parts by weight of boric acid, with vigorous stirring and allowing each added portion (of 4.5 parts by weight) to dissolve before adding the next portion. The obtained solution was kept under vigorous stirring at 86° C. for 3 h, then at 55° C. and gentle stirring for 12 h, at which time, surface active agent from Oy Faintend Ltd (5 parts by weight) was added and the gentle stirring is continued for one more hour at 55° C.

The obtained solution may be used as a flame retardant composition to increase the fire resistance of any material.

### Example 3

Purified water (40 parts by weight) was heated to 86° C. and at this temperature, borax (20 parts by weight) and boric acid (40 parts by weight) were added in 10 incremental portions of 3.0 parts by weight of borax and 1.5 parts by weight of boric acid, with vigorous stirring and allowing each added portion (of 6.0 parts by weight) to dissolve before adding the next portion. The obtained solution was kept under vigorous stirring at 86° C. for 3 h, then at 55° C. and gentle stirring for 12 h. The solution then was kept at 15° C. and under conditions allowing the water to evaporate. The dry material was ground in a ball mill to provide a powder.

The obtained powder may be used as a flame retardant composition to increase the fire resistance of any material.

### Example 4

Glycerol (66 parts by weight) was heated to 85° C. and at this temperature, borax (17 parts by weight) and boric acid (17 parts by weight) were added in 10 incremental portions of 1.7 parts by weight of each, with vigorous stirring and allowing each added portion (of total 3.4 parts by weight) to dissolve before adding the next portion. The obtained solution was kept under vigorous stirring at 85° C. for 2 h, then at 55° C. and gentle stirring for 10 h.

The obtained solution may be used as a flame retardant composition to increase the fire resistance of any material.

### Example 5

The flame retardant composition of Example 1, (35 parts by weight), at a temperature of 40° C., was admixed with a polyester resin (100 parts by weight), also at a temperature of 40° C., with stirring. The polyester resin composition then was processed in the usual way in order to obtain a final product.

### Example 6

The flame retardant composition of Example 2 in an amount of 20% by total weight was sprayed onto the surface of expanded PVC. The surface was allowed to dry for 2 hours in room temperature (about 20° C.).

### Example 7

A polyester resin (200 g) was mixed with 70 g of the flame retardant composition of Example 1 and to the obtained mixture a hardener as recommended by the resin manufacturer was added, giving a solid test specimen. The test specimen was put into to the flame of a gas burner (at a temperature of 3600° C.) without catching fire for at least 30 minutes.

1. A method of increasing fire resistance of a synthetic material which comprises bringing the material into contact with a fire retardant composition comprising boric acid and a salt of boric acid, provided that said fire retardant composition does not contain carboxymethylcellulose.

2. The method according to claim 1, wherein the salt of boric acid is borax.

3. The method according to claim 2, wherein the salt of boric acid is selected from Na₂B₄O₇.5H₂O and Na₂B₄O₇.10H₂O.

4. The method according to claim 1, wherein the fire retardant composition comprises a liquid vehicle for the boric acid and boric acid salt.

5. The method according to claim 4, wherein the liquid vehicle is water or one or more organic solvents, or a mixture thereof.

6. The method according to claim 1 wherein the fire retardant composition is a powder or granulate.

7. The method according to claim 1, wherein the synthetic material is a polymeric material.

8. The method according to claim 1, wherein the synthetic material is a thermosetting resin, a thermoplastic resin, an elastomer, a paint, a lacquer, a rubber, a woven fibre, a non-woven fibre, a glue, a foam, a carbon fibre, a glass fibre, or a gelcoat.

9. The method according to claim 1, wherein the fire-retardant composition is mixed with the synthetic material.

10. The method according to claim 1, wherein the fire retardant composition is applied to the surface of the synthetic material and optionally allowed to impregnate part or all of the material.

11. A synthetic material of improved fire resistance obtainable by a method according to claim 1.

12. A method for preparing a fire retardant composition comprising admixing boric acid and a salt of boric acid, and optionally a liquid vehicle for the acid and salt, provided that the fire retardant composition does not contain carboxymethylcellulose.

13. The method according to claim 12, wherein the salt of boric acid is borax.

14. The method according to claim 12, wherein the liquid vehicle is water or one or more organic solvents, or a mixture thereof.

15. A fire retardant composition obtainable by a method according to claim 12.

16. The method according to claim 2, wherein the fire retardant composition comprises a liquid vehicle for the boric acid and boric acid salt.

17. The method according to claim 3, wherein the fire retardant composition comprises a liquid vehicle for the boric acid and boric acid salt.

18. The method according to claim 2, wherein the fire retardant composition is a powder or granulate.

19. The method according to claim 3, wherein the fire retardant composition is a powder or granulate.

20. The method according to claim 13, wherein the liquid vehicle is water or one or more organic solvents, or a mixture thereof.
